(19) United States
(12) Patent Application Publication
(10) Pub. No.: US 2021/0257800 A1
(43) Pub. Date: Aug. 19, 2021

(54) FIBER LASER RESONATORS WITH INTRACAVITY FIBER BRAGG GRATINGS FOR IMPROVING LASING EFFICIENCY BY SUPPRESSING STIMULATED RAMAN SCATTERING

(71) Applicant: ITF Technologies Inc., Montreal (CA)

(72) Inventors: Benoit Sévigny, Montreal (CA); André Vincelette, Montreal (CA)

(21) Appl. No.: 17/177,162

(22) Filed: Feb. 16, 2021

Related U.S. Application Data
(63) Continuation of application No. PCT/CA2021/050157, filed on Feb. 12, 2021.
(60) Provisional application No. 62/977,042, filed on Feb. 14, 2020.
(60) Provisional application No. 62/977,042, filed on Feb. 14, 2020.

(51) Int. Cl. H01S 3/067; H01S 3/08

(52) U.S. Cl. CPC H01S 3/0675; H01S 3/08013

(57) ABSTRACT

Designs of fiber lasers with a laser resonator with an intracavity Raman-suppressing slanted fiber Bragg sating to provide bidirectional suppression of Raman light.

### CROSS-REFERENCE TO RELATED APPLICATIONS

This patent document claims the benefits of and priority to U.S. Provisional Patent Application No. 62/977,042, filed on Feb. 14, 2020. In addition, this patent document is a continuation of and claims the benefits of and priority to International Patent Application No. PCT/CA2021/050157, filed in Canada on Feb. 12, 2021, which further claims benefits of and priority to U.S. Provisional Patent Application No. 62/977,042, filed on Feb. 14, 2020. The entire contents of the before-mentioned patent applications are incorporated by reference as part of the disclosure of this application.

### TECHNICAL FIELD

This patent document relates to fiber lasers and their implementations.

### BACKGROUND

Fiber lasers can be constructed by using laser resonators formed in optical fiber or fiber segments containing a laser gain medium, usually doped fiber gain sections. Optical fiber, like many other optical media, exhibits nonlinear optical effects which he used beneficially in some devices such as fiber Raman amplifiers and can also lead to undesired consequences such as limiting fiber laser output power levels. Pump light and laser light in fiber lasers can be at relatively high optical intensities and thus can lead to the nonlinear stimulated Raman scattering (SRS) in fiber which in turn transfers optical energy at one optical wavelength into an SRS signal at a different optical wavelength. This transfer of optical energy due to SRS can limit the optical efficiency for converting pump light into laser light in various fiber lasers. Accordingly, it is desirable to suppress such undesired generation of SRS light in such fiber lasers.

### SUMMARY

In one aspect, the disclosed fiber laser technology in this patent document can be implemented to provide, a fiber laser that includes a laser resonator that includes a first fiber gain section and a second fiber gain section that produce an optical gain at a laser wavelength to amplify light at the laser wavelength, a passive fiber segment coupled between the first sand second fiber gain sections; and a slanted fiber Bragg grating formed in the passive fiber segment to have tilted fiber gratings that are not perpendicular to a longitudinal direction of the passive fiber segment to reflect light at one or more Raman wavelengths of Raman scattering inside the laser resonator to direct light, that is at the one or more Raman wavelengths and in two opposite directions inside the laser resonator, out of the fiber core of the passive fiber segment and out of the laser resonator.

In some implementations, in the above fiber laser, the slanted fiber Bragg grating can be implemented to include a spatially chirped grating period to reflect a range of Raman wavelengths of Raman scattering inside the laser resonator to cover Raman wavelengths of Raman generated over a range of different operating temperatures.

In some implementations, the laser resonator can include a first high reflectivity fiber grating at a first end of the laser resonator and a second fiber grating at a second end of the laser resonator to transmit a portion of the laser light at the laser wavelength as a laser output of the laser resonator and the fiber laser can further include an external fiber gain section located outside the laser resonator at a location to optically receive and amplify the laser output of the laser resonator; and an external slanted fiber Bragg grating located between the second fiber grating at the second end of the laser resonator and the external fiber gain section, and configured to have tilted fiber gratings to reflect light at one or more Raman wavelengths of Raman scattering and to direct light at the one or more Raman wavelengths away from the laser output.

The above and other aspects and their implementations are described in greater detail in the description, the drawings and the claims.

### BRIEF DESCRIPTION OF THE DRAWINGS

FIG. 1 shows an example of a fiber laser having an intracavity slanted SRS-suppressing fiber Bragg grating (FBG) based on the disclosed technology.

FIG. 2 shows an example of a bidirectional intracavity slanted SRS-suppressing fiber Bragg grating(FBG) based on the disclosed technology.

### DETAILED DESCRIPTION

In fiber lasers, the stimulated Raman scattering (SRS) occurs due to the third order nonlinear optical interaction between light and molecular vibrations in the fiber material, phonons or other excitations in the fiber material to produce light at an SRS frequency that is shifted up or down in frequency from the original light. A fiber laser designed to produce laser light at a laser wavelength can lose the laser power due to the transfer of the optical energy at the laser wavelength to an SRS light at a frequency shifted SRS wavelength, which can be up shifted in frequency as a anti-Stokes signal or down shifted in frequency as a Stokes signal.

One approach to suppressing this undesired SRS light in fiber lasers is to provide one or more fiber Bragg gratings (FBGs) that are structured to selectively reflect SRS light at an angle with respect to the optic axis of the fiber so as to direct the SRS light out of the fiber, thus preventing the SRS light from staying in the fiber laser resonator and from being amplified. Such a FBG can be formed in the fiber core with a spatial modulation of the refractive index of the fiber core to form slanted gating fringes that are not perpendicular to the longitudinal direction of the fiber core but are slanted at an angle with respect to the perpendicular direction to the fiber core. Some examples of fiber lasers using such slanted FBGs can be found in, e.g., U.S. Pat. No. 7,590,155 B2 entitled “Hybrid high power laser to achieve high repetition rate and high pulse energy,” U.S. Pat. No. 7,912,099 B2 entitled “Method and apparatus for preventing distortion of powerful fiber-laser systems by backreflected signals,” U.S. Pat. No. 9,634,462 B2 entitled “Slanted FBG for SRS suppression,” and U.S. Pat. No. 10,393,955 B2 entitled “Optical fiber filter of wideband deleterious light and uses thereof.” Those patents are incorporated by reference as part of the disclosure of this patent document.

This patent document discloses novel fiber laser designs using intracavity slanted FBGs inside fiber laser resonators with improved SRS suppression and other technical benefits.

The fiber laser designs disclosed in this patent document can be implemented with a laser resonator or amplification cavity by placing a doped fiber length between two non-slanted FBGs as two end reflectors of the laser resonator to reflect the desired lasing wavelength along the fiber core. Laser pump light source, which may include one or more pump diodes, can be used to supply the optical pump light coupled in the doped fiber that will absorb the pump light and emit laser light at the desired laser wavelength. Between the laser pump light source (e.g., pump diodes) and the doped fiber a strong FBG (e.g., >99.5% reflection at the laser wavelength) is provided for reflecting back the laser light in the doped fiber and a second FBG reflector, e.g., weaker FBG reflector (e.g., 5% to 20% reflection at the laser wavelength in some devices) on the other side of the doped fiber segment also serving as a laser output coupler (OC) to output the laser light.

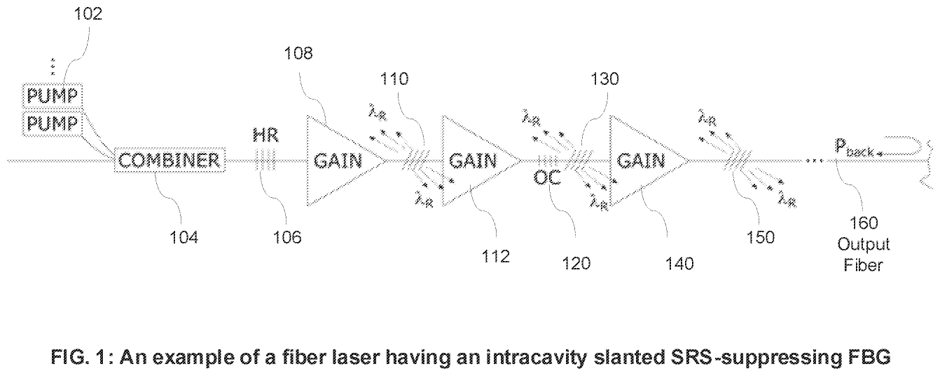

FIG. 1 shows an example of a fiber laser with a laser resonator formed by a first FBG 106 as a high reflector (HR) and a second FBG 120 as a reflector and an output coupler (OC) 114 and an intracavity SRS-suppressing slanted FBG 110.

In this example, the fiber laser resonator is formed by the FBG HR 106 and OC FBG 120 formed in the fiber core and two or more fiber gain sections 108 and 112 inside the laser resonator. The laser pump light source 102 includes two or more pump laser diodes to produce different pump beams that are coupled into a pump light coupler 104 in form of a fiber combiner to couple the combined pump light into the fiber at a location on the left-hand side of the HR FBG 106 of the laser resonator. For example, in some implementations, the fiber laser can be implemented by double-clad fiber with a large multi-mode cladding pump light guide to receive high power pump light and the fiber combiner may be a coupler to couple the combined pump light into the fiber cladding. Various optical pumping configurations may be used beyond what is illustrated, including, for example, a counter pumping configuration where two pump light beams are directed to the gain section in opposite directions from both sides of the gain section.

Notably, this fiber laser includes an intracavity slanted SRS-suppressing FBG 110 formed between the two fiber gain sections 108 and 112 to simultaneously direct SRS light in opposite directions from the two fiber gain sections 108 and 112 out of the fiber core and the fiber-based laser resonator. As illustrated, the arrowed lines represent the reflected SRS light from the intracavity slanted SRS-suppressing FBG 110. This example further shows the use of one or more additional slanted SRS-suppressing FBGs 130 and 150 outside the laser resonator in the laser output fiber 160 with one or more laser amplifiers 140 to suppress undesired SRS light. Specifically, at the output fiber line 160 on the right-hand side of the OC FBG 120, a first slanted SRS-suppressing FBG 130 is provided at a location between the OC FBG 120 and the external fiber amplifier 140 and a second slanted SRS-suppressing FBG 150 is provided downstream from the external fiber amplifier 140.

With this fiber laser design, the power that can be generated is limited by the apparition of Raman scattering, a non-linear effect, that will cause degradation of the cavity efficiency and output laser beam quality. The slanted (tilted) FBG 110 that couples the light at the SRS wavelength out of the fiber core and into the fiber cladding while allowing the light at non-SRS wavelength to pass through. Accordingly, the undesired SRS light is directed out of the fiber core instead of reflecting it backward in the fiber core, at the Bragg wavelength which is the Raman wavelength. Thus, as Raman scattering is initiated, the Raman light is removed from the fiber lasing path by the slanted FBG 110 and the power of the laser light can be increased.

The designs of fiber lasers based on the disclosed technology in this patent document are in part based on the recognition that one harmful mechanism is the forward. Raman scattering exiting the cavity and being reflected back in the cavity by downstream reflection, such as delivering fiber end, and thus being amplified in the passive fiber where the signal power is highest. Thus, an effective slanted FBG for Raman stripping from the core should be strategically placed at the exit of the laser resonator but within the laser resonator, outside of the laser resonator, and should be bidirectional to provide SRS suppression in both directions. Placing a secondary slanted FBG for Raman stripping from the core in the laser resonator may enable increasing power limitation, in addition to a grating outside the cavity. The location of the slanted FBG 110 in the laser resonator should be carefully designed based on the specific laser designs. For example, in some implementations, the location of the slanted FBG 110 in the laser resonator may be determined based on the relative power levels of the backward and forward Raman scattering signals. For example, inserting the slanted FBG 110 in the middle of the gain fiber (e.g., as illustrated between the two fiber gain sections 108 and 112) in the laser resonator would be beneficial if backward and forward Raman scattering are similar or approximately equal in their power levels but, this location may be off the middle if the backward and forward Raman scattering signals are different in power.

In some implementations, fiber lasers based on the disclosed technology in this patent document can be designed to include cascading amplification resonators or cavities, in which a slanted FBG for Raman stripping can be placed between each amplification stage and between the last one and the delivering fiber; optionally, also a slanted FBG for Raman stripping in some or all amplification cavities.

In some implementations, the slanted FBG for Raman stripping may be fabricated in non-doped or passive fiber segment within the fiber laser resonator, a different design from other designs of placing the slated FBG in the fiber gain section. In some implementations, the slanted FBG may be a chirped FBG with a spatially varying grating period along the FBG and that the light is entering by the long period end and exiting by the short period end. The slanted angle can be in various angles, e.g., less than 6° or at larger slanted angle greater than 6°. In some designs, one or more chirped slanted FBGs for Raman stripping may be designed to have a relatively wide Bragg wavelength range to cover the Raman wavelengths at different operating temperatures to effectuate Raman stripping at different operating temperatures.

The disclosed fiber lasers with intracavity slanted SRS-suppressing FBGs can be configured in various ways. For example, a slanted FBG Raman stripper may be provided between the laser resonator (amplification cavity) and the delivery fiber; an additional slanted FBG Raman stripper may be placed inside the laser resonator or amplification cavity, most likely on a length of passive fiber inserted at an optimal location along the doped fiber length; and, in some applications, it is possible to cascade this architecture with a slanted FBG Raman stripper between each amplification stage and, optionally, another one inside each amplification stage.

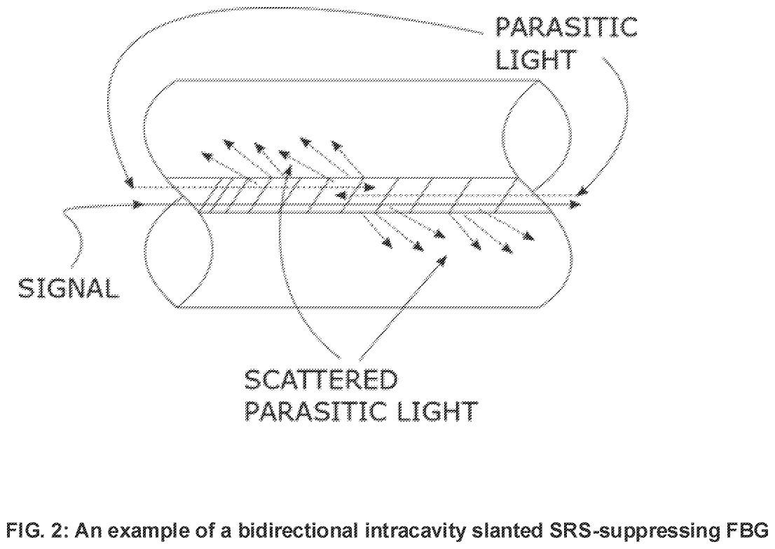

FIG. 2 shows an example of an intracavity slanted SRS-suppressing FBG as a bidirectional slanted SRS-suppressing FBG to direct incoming SRS light out of the fiber core in both directions.

The examples in FIGS. 1 and 2 are for a fiber laser that includes a laser resonator that includes a first fiber gain section and a second fiber gain section that produce an optical gain at a laser wavelength to amplify light at the laser wavelength, a passive fiber segment coupled between the first sand second fiber gain sections; and a slanted fiber Bragg grating formed in the passive fiber segment to have tilted fiber gratings that are not perpendicular to a longitudinal direction of the passive fiber segment to reflect light at one or more Raman wavelengths of Raman scattering inside the laser resonator to direct light, that is at the one or more Raman wavelengths and in two opposite directions inside the laser resonator, out of the fiber core of the passive fiber segment and out of the laser resonator. In some implementations, in the above fiber laser, the slanted fiber Bragg grating can be implemented to include a spatially chirped grating period to reflect a range of Raman wavelengths of Raman scattering inside the laser resonator to cover Raman wavelengths of Raman generated over a range of different operating temperatures.

In some implementations, the laser resonator can include a first high reflectivity fiber grating at a first end of the laser resonator and a second fiber grating at a second end of the laser resonator to transmit a portion of the laser light at the laser wavelength as a laser output of the laser resonator and the fiber laser can further include an external fiber gain section located outside the laser resonator at a location to optically receive and amplify the laser output of the laser resonator; and an external slanted fiber Bragg grating located between the second fiber grating at the second end of the laser resonator and the external fiber gain section, and configured to have tilted fiber gratings to reflect light at one or more Raman wavelengths of Raman scattering and to direct light at the one or more Raman wavelengths away from the laser output.

Additional features of the current fiber lasers with intracavity slanted SRS-suppressing FBGs are as follows.

In some implementations, the FBG Raman stripper can be written in passive fiber compatible (low splice losses) to the doped amplification fiber. Passive fiber has a more stable chemical composition that is more controllable to change by laser energy exposition (interferometric photolithography) to form the fiber Bragg grating in its core. In addition, in passive fiber we can sent a light signal in the core of the fiber to monitor exactly the spectral intensity of the FBG being formed and control the exposition according to it; while in the doped fiber, some of that monitoring light signal can be absorbed.

In some implementations, the intracavity slanted SRS-suppressing FBG can be a spatially chirped FBG to cover the full Raman spectrum generated in a fiber laser. In such a design, there is a critical angle below which a directionality must be respected, the Raman signal must enter by the highest wavelength to the lowest wavelength of the chirped Bragg grating to be coupled into the cladding of the fiber. The designs here can use a slanted angle above that threshold where the Raman is coupled to the cladding regardless of the directionality of the chirp to the Raman signal direction, thus enabling to strip both Raman component going forward and backward. In typical fiber laser configuration, this threshold angle is about 6°, but this depends on specific fiber used characteristics and pumping scheme.

In fiber lasers, the generated Raman signal has two components one going forward with the amplified signal and one going backward in the inverse direction of the amplified Our approach of placing the FBG Raman stripper in the center portion of the amplification cavity, in between amplification stages and after the last amplification stage enables to strip from the core all the components of the generated Raman signals. In contrast, U.S. Pat. No. 7,590,155 focuses on stripping only the backward component, while U.S. Pat. No. 9,634,462 focuses on stripping only the forward component by placing the FBG Raman stripper just before the end of the cavity; In U.S. Pat. No. 10,393,955, each component of the Raman signal must be filtered by individual FBG Raman stripper due to their chirp directionality towards Raman signal directionality.

The spectral filtering of FBG Raman stripper may drift towards longer wavelengths with an increase in temperature. Accordingly, the present FBG Raman stripper is designed to have a spectral bandwidth to cover all the Raman spectrum at all operating temperatures. Such chirped FBGS are used in cascading multiple FBGs.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A fiber laser, comprising:
a laser resonator that includes a first fiber gain section and a second fiber gain section that produce an optical gain at a laser wavelength to amplify light at the laser wavelength, a passive fiber segment coupled between the first sand second fiber gain sections; and
a slanted fiber Bragg grating formed in the passive fiber segment to have tilted fiber gratings that are not perpendicular to a longitudinal direction of the passive fiber segment to reflect light at one or more Raman wavelengths of Raman scattering inside the laser resonator to direct light, that is at the one or more Raman wavelengths and in two opposite directions inside the laser resonator, out of the fiber core of the passive fiber segment and out of the laser resonator.

2. The fiber laser as in claim 1, wherein the slanted fiber Bragg grating has a spatially chirped grating period to reflect a range of Raman wavelengths of Raman scattering inside the laser resonator to cover Raman wavelengths of Raman generated over a range of different operating temperatures.

3. The fiber laser as in claim 1, wherein the laser resonator includes a first high reflectivity fiber grating at a first end of the laser resonator and a second fiber grating at a second end of the laser resonator to transmit a portion of the laser light at the laser wavelength as a laser output of the laser resonator, and
wherein the fiber laser further includes:
an external fiber gain section located outside the laser resonator at a location to optically receive and amplify the laser output of the laser resonator; and
an external slanted fiber Bragg grating located between the second fiber grating at the second end of the laser resonator and the external fiber gain section, and configured to have tilted fiber gratings to reflect light at one or more Raman wavelengths of Raman scattering and to direct light at the one or more Raman wavelengths away from the laser output.

4. The fiber laser as in claim 1, further comprising:
an additional laser resonator that includes a fiber gain section to produce an optical gain at a laser wavelength to amplify light at the laser wavelength, and that is coupled to receive light output from the laser resonator to amplify the receive light;
a fiber line coupled between the between the laser resonator and the additional laser resonator to transmit light between the laser resonator and the additional laser resonator; and
an inter-resonator slanted fiber Bragg grating formed in the fiber line coupled between the laser resonator and the additional laser resonator to suppress Raman scattering light, the inter-resonator slanted fiber Bragg grating structured to have tilted fiber gratings that to reflect light at one or more Raman wavelengths of Raman scattering to direct Raman scattering light out of the fiber line.

5. The fiber laser as in claim 4, further comprising:
an intra-resonator slanted fiber Bragg gating formed in the additional laser resonator to include tilted fiber gratings to reflect Raman scattering light inside the additional laser resonator out of the additional laser resonator.
